(19) United States
(12) Patent Application Publication
(10) Pub. No.: US 2009/0282130 A1
(43) Pub. Date: Nov. 12, 2009

(54) RESOURCE SHARING VIA CLOSE-PROXIMITY WIRELESS COMMUNICATION

(75) Inventors: Zoe ANTONIOU, Belmont, MA (US); Jacob STRAUSS, Roslindale, MA (US)

Correspondence Address: Locke Lord Bissell & Liddell LLP;Attn: IP Docketing, Three World Financial Center, New York, NY, 10281-2101, US

(73) Assignee: NOKIA CORPORATION, Espoo (FI)

(21) Appl. No.: 12/119,116

(22) Filed: May 12, 2008

(51) Int. Cl. G06F 15/177

(52) U.S. Cl. 709/220

(57) ABSTRACT

A system for sharing information between users and/or devices via close-proximity wireless communication. Devices located in close-proximity may be configured to transmit/receive wireless messages including information used to configure at least one of the devices. The configuration information may include, for example, information needed to add another user and/or device to a network group residing on the device receiving the configuration information. The configuration information may also serve other purposes, for example, to grant access to a resource located remotely to the device receiving the configuration information so that this wireless-enabled apparatus may remotely access and/or control the remote resource.

### BACKGROUND

1. Field of Invention

Various embodiments of the present invention relate to a social networking and/or resource sharing system, and more specifically, to a system for conveying, via close-proximity wireless communication, information usable in the automatic configuration of resource access.

2. Background

Modern society has adopted, and is becoming reliant upon, devices for wireless communication. For example, cellular telephones continue to proliferate in the global marketplace due to technological improvements in both communication quality and device functionality. These wireless communication devices (WCDs) have become common for both personal and business use, allowing users to transmit and receive voice, text and graphical data from a multitude of geographic locations. The communication networks utilized by these devices span different frequencies and cover different transmission distances, each having specific features desirable for various applications.

Cellular networks facilitate WCD communication over large geographic areas. These network technologies have commonly been divided by generations, starting in the late 1970s to early 1980s with first generation (1G) analog cellular telephones that provided baseline voice communication to modern digital cellular handsets. For example, Global System for Mobile communication (GSM) is a widely employed 2G digital cellular network communicating in the 900 MHZ/1.8 GHZ bands in Europe and at 850 MHz and 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, Integrated Services Digital Network (ISDN) and Plain old telephone service (POTS) users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that may avoid some of the problems seen in large cellular networks. Bluetooth™ is an example of a short-range wireless technology quickly gaining acceptance in the marketplace. A 1 Mbps Bluetooth™ radio may transmit and receives data at a rate of 720 Kbps within a range of 10 meters, and may transmit up to 100 meters with additional power boosting. Enhanced data rate (EDR) technology is also available that may enable maximum asymmetric data rates of 1448 Kbps for a 2 Mbps connection and 2178 Kbps for a 3 Mbps connection. A user does not actively instigate a Bluetooth™ network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth™, other examples of short-range wireless technology include wireless local area networking (WLAN, for example, “Wi-Fi” local access points communicating using the IEEE 802.11 standard), wireless universal serial bus (WUSB), ultra-wide band (UWB), ZigBee (e.g., 802.15.4, 802.15.4a), and ultra-high frequency radio frequency identification (UHF RFID). All of these wireless mediums have features and/or advantages that may make them more appropriate for various applications.

More recently, manufacturers have also begun to incorporate various resources for providing enhanced functionality in WCDs (e.g., components and software for performing close-proximity wireless information exchanges). Sensors and/or scanners may be used to read visual or electronic information into a device. A transaction may involve a user holding their WCD in proximity to a target, aiming their WCD at an object (e.g., to take a picture) or sweeping the device over a printed tag or document. Exemplary machine-readable mediums in this category may include radio frequency identification (RFID), specific RFID configurations such as Near field communication (NFC), Infra-red (IR) communication, optical character recognition (OCR) and various other types of visual, electronic and magnetic scanning that may be used to quickly input desired information into a WCD without the need for manual entry by a user.

The desire for users to employ wireless devices in multiple settings continues to keep pace with new communication enhancements incorporated in these devices. For example, the advent of text messaging in mobile devices has led to the mainstream usage of this type of interaction for regular communication, which further opened the door for enhancements such as wireless email access, wireless Internet access, etc. Moreover, this demonstrated ability to mobilize resources that were previously thought only to be available through stationary devices has created the desire to tie other resources to wireless apparatuses so that they may utilize, and/or have access to, these resources regardless of the location. These resources may include various applications like stationary computers, appliances, security devices (e.g., cameras), etc.

Other applications that may be facilitated by the aforementioned communication innovations may include more esoteric uses of the above resources. For example, interpersonal relations that previously were only done face-to-face may now be facilitated by a WCD. Digital social networking continues to grow in popularity due to the busy lifestyle habits maintained in today's society. These systems allow users to interact via voice, text and/or video in manner that was originally associated only with direct contact. As the popularity of digital social networks grows in stationary configurations, similar functionality will be desired in mobile devices.

However, the population of wireless device users is both large and diverse. This user group may include operators of different ages, education, backgrounds, etc., and therefore, of different skill levels. Many of these users may desire to utilize wireless communication for enhanced operations such as accessing and/or controlling remote resources, sharing user and/or device information with other users and/or devices such as in the digital social networking, etc. However, the configuration required to engage in such functionality may be prohibitive to use.

In at least one scenario, a user with the skills required to operate a wireless device may not have the ability, or the desire, to manually set the communication configuration of the device to enable the above exemplary functionality. Further, users may want to share personal, device and/or configuration information for accessing remote resources with other devices and/or users. Currently there is no way to pass this information, and/or to set the wireless configuration of a device, other than to convey the information between users for use in manual configuration.

### SUMMARY

Various embodiments of the present invention are directed to at least a method, system, device and computer program for sharing information between users and/or devices via close-proximity wireless communication. Devices located in close-proximity may be configured to transmit/receive wireless messages including information used to configure at least one of the devices. The configuration information may include, for example, information needed to add another user and/or device to a network group residing on the device receiving the configuration information. The configuration information may also serve other purposes, for example, to grant access to a resource located remotely to the device receiving the configuration information so that this wireless-enabled apparatus may remotely access and/or control the remote resource.

In at least one embodiment of the present invention, information corresponding to resource configurations residing in an apparatus may be included in messages for transmission to other devices via close-proximity wireless communication. The configuration information may include, for example, personal information utilized in social networking, apparatus information, access information to resources outside of the apparatus, etc. In an exemplary scenario wherein information may be shared, users may activate a mode in their devices to allow the transmission of the configuration information from one device to another via wireless communication. For example, a user may activate a mode in a wireless apparatus that prompts the user to hold the apparatus in proximity to the device from which configuration information is to be obtained.

For instance, a user may place a wireless apparatus in close proximity to a device containing desired configuration information and then trigger communication (e.g., with a button press). Configuration information may then be wirelessly transferred from the source device to the requesting apparatus. The information may be conveyed via various close-proximity (e.g., near field) communication mediums. The receiving device may then interpret the received data in order to implement configuration. In some cases, for example, the received information may require additional communication before configuration can be completed. In such a scenario the receiving device may endeavor to create another wireless link (e.g., “out-of-band” connection) in order to complete configuration. Another situation includes pre-configuring, or bootstrapping, one or more wireless communication mediums in preparation for establishing a link. After completing configuration, access may be granted to resources, for example as described above.

### DESCRIPTION OF DRAWINGS

The invention will be further understood from the following detailed description of various exemplary embodiments, taken in conjunction with appended drawings, in which:

FIG. 1 discloses an exemplary wireless operational environment, including wireless communication mediums of different effective range.

FIG. 2 discloses a modular description of an exemplary wireless communication device usable with at least one embodiment of the present invention.

FIG. 3 discloses an exemplary structural description of the wireless communication device previously described in FIG. 2.

FIG. 4 discloses an exemplary wireless apparatus configuration including possible linked devices in accordance with at least one embodiment of the present invention.

FIG. 5 discloses an example scenario wherein a wireless device is configured manually in accordance with at least one embodiment of the present invention.

FIG. 6A discloses an exemplary “tap” wireless configuration procedure in accordance with at least one embodiment of the present invention.

FIG. 6B discloses an example of configuration information transmission in accordance with at least one embodiment of the present invention.

FIG. 6C discloses an example of configuration information reception in accordance with at least one embodiment of the present invention.

FIG. 6D discloses an example of Out-of-Band communication and service discovery configuration in accordance with at least one embodiment of the present invention.

FIG. 7A discloses an exemplary packet structure in accordance with at least one embodiment of the present invention.

FIG. 7B discloses a more detailed packet structure diagram in accordance with at least one embodiment of the present invention.

FIG. 8 discloses an exemplary user interface that may be implemented in accordance with an alternative embodiment of the present invention.

FIG. 9A discloses an example of MyNet Service Discovery implementation in a Linux environment in accordance with at least one embodiment of the present invention.

FIG. 9B discloses an example of a URL Sharing Application in a Linux environment in accordance with at least one embodiment of the present invention.

FIG. 10 discloses a flowchart for an exemplary communication process in accordance with at least one embodiment of the present invention.

### DESCRIPTION OF PREFERRED EMBODIMENT

While the present invention has been described in a variety of exemplary embodiments, various changes can be made therein without departing from the spirit and scope of the invention, as described in the appended claims.

### I. Wireless Communication Over Different Communication Networks

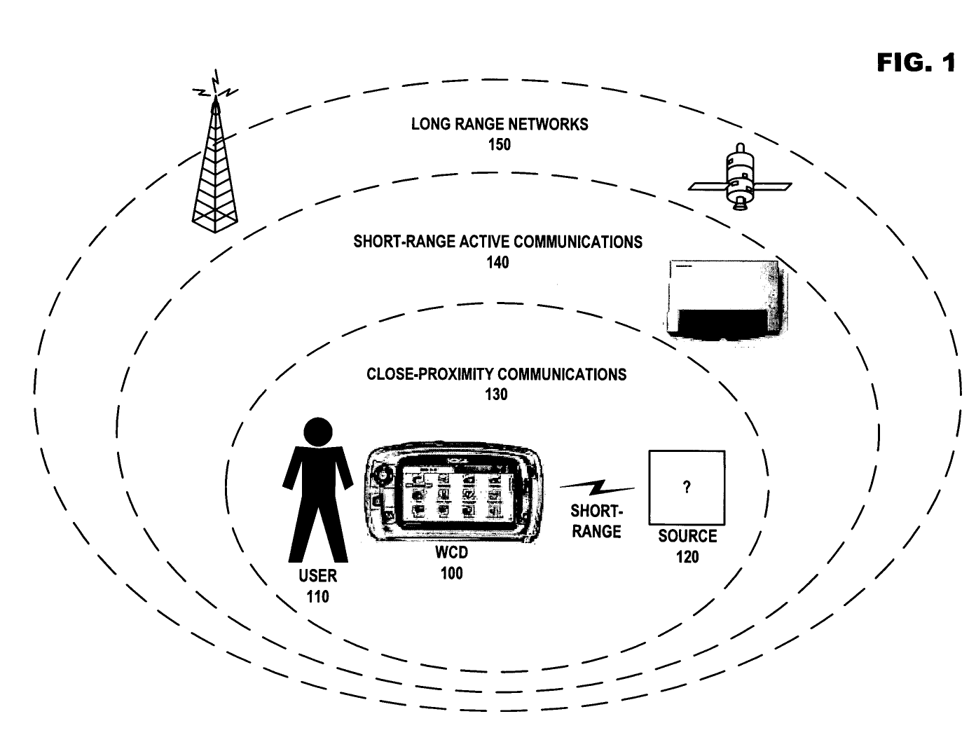

Wireless communication devices (WCD) may transmit and receive information over a wide array of communication networks, each with different advantages regarding speed, range, quality (error correction), security (encoding), etc. These characteristics may determine the amount of information that can be transferred to a receiving device and the duration of time for this information transfer. FIG. 1 includes a diagram of an exemplary WCD and how it may interact with various types of wireless technologies.

In the example pictured in FIG. 1, user 110 may be an operator of WCD 100. This device may be anything from a basic cellular handset to a more complex device such as a wirelessly enabled palmtop or laptop computer. Close-proximity communications 130 may include various inter-device and/or transponder-type interactions (e.g., wherein normally only the scanning device requires its own power source) conducted over very short distances. RFID is an example of a wireless technology that may be employed to support either device-to-device communication (e.g., where both devices may actively communicate), or alternatively, in device-to-tag implementations where an active device may be configured to scan a passive transponder. For example, communications may be established between devices when WCD 100 transmits a wireless message to source 120 requesting the establishment a wireless link, or may initiated by WCD 100 using a scanning signal to obtain data when source 120 is a transponder-type device.

More specifically, in exemplary transponder-type communications a transponder within source 120 may utilize energy and/or a clock signal contained within the scanning signal provided by WCD 100 to respond with data stored in the transponder. While these interactions may typically occur when devices are within inches of each other, some technologies may have an effective transmission range on the order of ten feet, and may be able to deliver stored data in amounts from a bit to over a megabit (or 125 Kbytes) relatively quickly. These features make such technologies well suited for identification purposes, such as to receive an account number for a public transportation provider, a key code for an automatic electronic door lock, an account number for a credit or debit transaction, etc.

The transmission range between two devices may be extended if both devices are capable of performing powered communication. Short-range active communication 140 includes applications wherein the sending and receiving devices are both active. An exemplary situation would include user 110 coming within effective transmission range of a Bluetooth™, WLAN, UWB, WUSB, etc. access point. In the case of Bluetooth™, a network may automatically be established to transmit information to WCD 100 possessed by user 110. The amount of information to be conveyed is unlimited, except that it must all be transferred in the time when user 110 is within effective transmission range of the access point. Due to the higher complexity of these wireless networks, additional time is also required to establish the initial connection to WCD 100, which may be increased if many devices are queued for service in the area proximate to the access point. The effective transmission range of these networks depends on the technology, and may be from some 30 ft. to over 300 ft. with additional power boosting.

Long-range networks 150 are used to provide virtually uninterrupted communication coverage for WCD 100. Land-based radio stations or satellites are used to relay various communication transactions worldwide. While these systems are extremely functional, the use of these systems is often charged on a per-minute basis to user 110, not including additional charges for data transfer (e.g., wireless Internet access). Further, the regulations covering these systems may cause additional overhead for both the users and providers, making the use of these systems more cumbersome.

### II. Wireless Communication Device

As previously described, the present invention may be implemented using a variety of wireless communication equipment. Therefore, it is important to understand the communication tools available to user 110 before exploring the present invention. For example, in the case of a cellular telephone or other handheld wireless devices, the integrated data handling capabilities of the device play an important role in facilitating transactions between the transmitting and receiving devices.

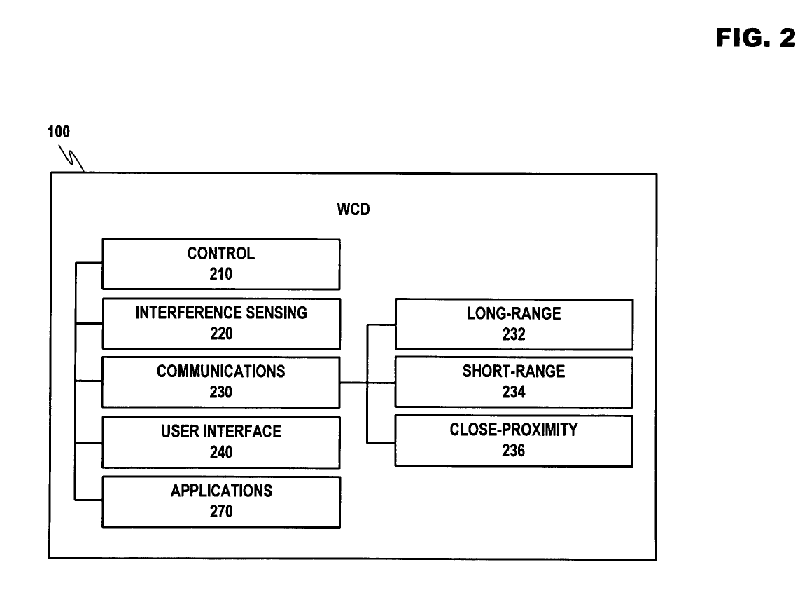

FIG. 2 discloses an exemplary modular layout for a wireless communication device usable with the present invention. WCD 100 is broken down into modules representing the functional aspects of the device. These functions may be performed by various combinations of the software and/or hardware components discussed below.

Control module 210 may regulate operation of the device. Inputs may be received from various other modules included within WCD 100. For example, interference sensing module 220 may use various techniques known in the art to sense sources of environmental interference within the effective transmission range of the wireless communication device. Control module 210 may interpret these data inputs, and in response, may issue control commands to the other modules in WCD 100.

Communications module 230 incorporates all of the communication aspects of WCD 100. As shown in FIG. 2, communications module 230 may include, for example, long-range communications module 232, short-range communications module 234 and close-proximity communications module 236. Communications module 230 may utilize one or more of these sub-modules to receive a multitude of different types of communication from both local and long distance sources, and to transmit data to recipient devices within the transmission range of WCD 100. Communications module 230 may be triggered by control module 210, or by control resources local to the module responding to sensed messages, environmental influences and/or other devices in proximity to WCD 100.

User interface module 240 includes visual, audible and tactile elements which allow the user 110 to receive data from, and enter data into, the device. The data entered by user 110 may be interpreted by control module 210 to affect the behavior of WCD 100. User-inputted data may also be transmitted by communications module 230 to other devices within effective transmission range. Other devices in transmission range may also send information to WCD 100 via communications module 230, and control module 210 may cause this information to be transferred to user interface module 240 for presentment to the user.

Applications module 250 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

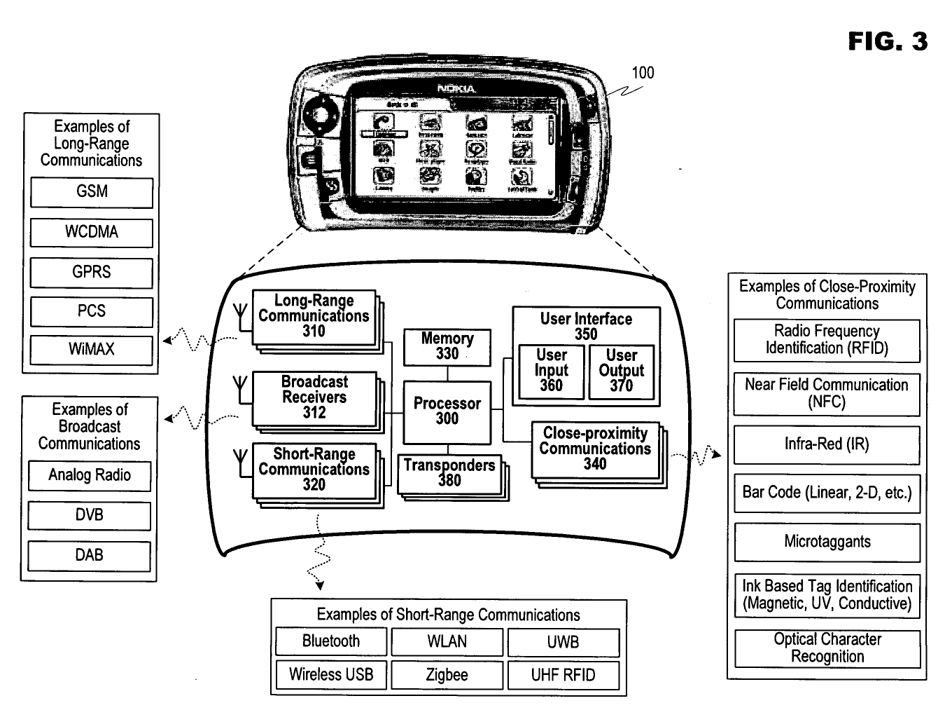

FIG. 3 discloses an exemplary structural layout of WCD 100 according to an embodiment of the present invention that may be used to implement the functionality of the modular system previously described in FIG. 2. Processor 300 controls overall device operation. As shown in FIG. 3, processor 300 is coupled to one or more communications sections 310, 320 and 340. Processor 300 may be implemented with one or more microprocessors that are each capable of executing software instructions stored in memory 330.

Memory 330 may include random access memory (RAM), read only memory (ROM), and/or flash memory, and stores information in the form of data and software components (also referred to herein as modules). The data stored by memory 330 may be associated with particular software components. In addition, this data may be associated with databases, such as a bookmark database or a business database for scheduling, email, etc.

The software components stored by memory 330 include instructions that can be executed by processor 300. Various types of software components may be stored in memory 330. For instance, memory 330 may store software components that control the operation of communication sections 310, 320 and 340. Memory 330 may also store software components including a firewall, a service guide manager, a bookmark database, user interface manager, and any communication utilities modules required to support WCD 100.

Long-range communications 310 performs functions related to the exchange of information over large geographic areas (such as cellular networks) via an antenna. These communication methods include technologies from the previously described 1G to 3G. In addition to basic voice communication (e.g., via GSM), long-range communications 310 may operate to establish data communication sessions, such as General Packet Radio Service (GPRS) sessions and/or Universal Mobile Telecommunications System (UMTS) sessions. Also, long-range communications 310 may operate to transmit and receive messages, such as short messaging service (SMS) messages and/or multimedia messaging service (MMS) messages. Various IP protocols may also be included in the long-range communication network category.

As a subset of long-range communications 310, or alternatively operating as an independent module separately connected to processor 300, transmission receiver 312 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 320 is responsible for functions involving the exchange of information across short-range wireless networks. As described above and depicted in FIG. 3, examples of such short-range communications 320 are not limited to Bluetooth™, WLAN, UWB and Wireless USB connections. Accordingly, short-range communications 320 performs functions related to the establishment of short-range connections, as well as processing related to the transmission and reception of information via such connections.

Close-proximity communications 340, also depicted in FIG. 3, may provide functionality related to the short-range scanning of machine-readable data. For example, processor 300 may control components in close-proximity communications 340 to generate RF signals for activating an RFID transponder, and may in turn control the reception of signals from an RFID transponder. Other examples of technologies for scanning machine-readable data that may be implemented in close-proximity communications 340 may include RFID functionality corresponding to Near field communication (NFC), IR communication, linear and 2-D (e.g., QR) bar code readers (including processes related to interpreting UPC labels), and optical character recognition devices for reading magnetic, UV, conductive or other types of coded data that may be provided in a tag using suitable ink. In order for close-proximity communications 340 to scan various types of machine-readable data, the input device may include optical detectors, magnetic detectors, CCDs or other sensors known in the art for interpreting machine-readable information.

As further shown in FIG. 3, user interface 350 is also coupled to processor 300. User interface 350 facilitates the exchange of information with a user. FIG. 3 shows that user interface 350 includes a user input 360 and a user output 370. User input 360 may include one or more components that allow a user to input information. Examples of such components include keypads, touch screens, and microphones. User output 370 allows a user to receive information from the device. Thus, user output portion 370 may include various components, such as a display, light emitting diodes (LED), tactile emitters and one or more audio speakers. Exemplary displays include liquid crystal displays (LCDs), and other video displays.

WCD 100 may also include one or more transponders 380. This is essentially a passive device that may be programmed by processor 300 with information to be delivered in response to a scan from an outside source. For example, at least one RFID scanner (or in a more specific scenario, at least one RFID scanner configurable to communicate utilizing NFC) may be mounted in an entryway may continuously emit radio frequency waves. When a person with a device containing transponder 380 walks through the door, the transponder is energized and may respond with information identifying the device, the person, etc. In addition, a scanner may be mounted (e.g., as discussed above with regard to examples of close-proximity communications 340) in WCD 100 so that it can read information from other transponders in the vicinity.

Hardware corresponding to communications sections 310, 312, 320 and 340 provide for the transmission and reception of signals. Accordingly, these portions may include components (e.g., electronics) that perform functions, such as modulation, demodulation, amplification, and filtering. These portions may be locally controlled, or controlled by processor 300 in accordance with software communication components stored in memory 330.

The elements shown in FIG. 3 may be constituted and coupled according to various techniques in order to produce the functionality described in FIG. 2. One such technique may link separate hardware components corresponding to processor 300, communications sections 310, 312, 320 and 340, memory 330, user interface 350, transponder 380, etc. together via one or more wired or wireless bus interfaces. Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 350 may interact with a communication utilities software component, also contained in memory 330, which provides for the establishment of service sessions using long-range communications 310 and/or short-range communications 320. The communication utilities component may include various routines that allow the reception of services from remote devices according to mediums such as the Wireless Application Medium (WAP), Hypertext Markup Language (HTML) variants like Compact HTML (CHTML), etc.

### III. Device and/or Network Interaction

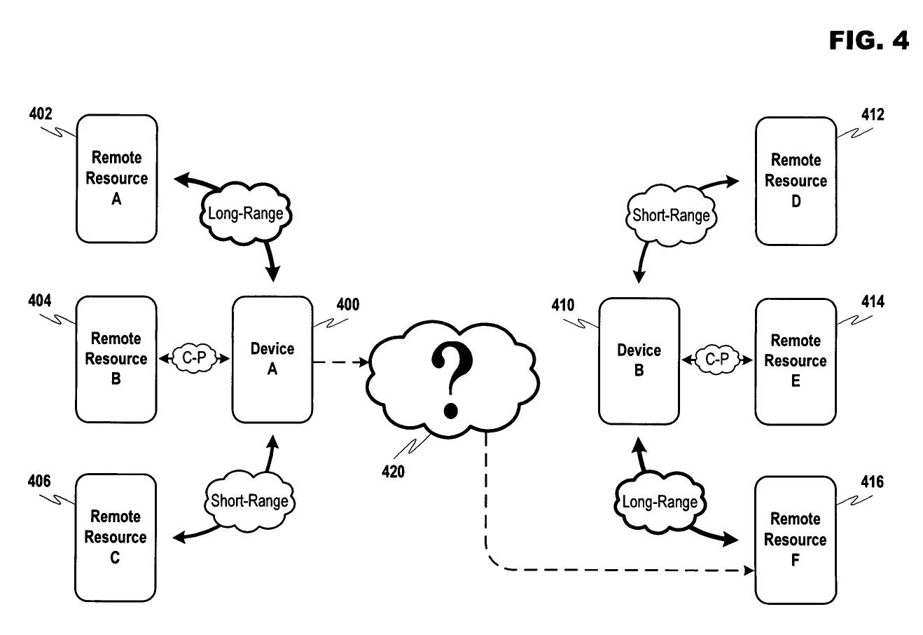

An example scenario is shown in FIG. 4 that will be utilized to explain various embodiments of the present invention. The practice of the various embodiments of the present invention are not strictly limited to the examples disclosed herein, and may be implemented in a multitude of configurations. In particular, various embodiments of the present invention may be implemented with various wireless-enabled apparatuses communicating using different wireless communication mediums. Disclosed devices and/or mediums are for explanation purposes only.

Two exemplary network groups are disclosed in FIG. 4. A first device A may, for example, be coupled to various remote resources. In this example, device A 400 is coupled to remote resource A 402 via long-range wireless communication. Similarly, remote resource B 404 is wirelessly coupled via close-proximity wireless communication (e.g., NFC), and remote resource C 406 is coupled by short-range wireless communication (e.g., Bluetooth™). Remote resources may include, but are not limited to, storage devices that may be configured to store information such as document data, multimedia files, etc., monitoring devices configured to provide visual and/or audio information, various apparatuses that are enabled for remote control, other wireless enabled devices that may, for example, be part of a network group with device A 400. Other devices that may be part of a network group with device A 400 may include, for example, WCDs 100 belonging to users who are members of the same digital social network.

Similarly, device B 410 may be linked to various remote resources 412-416 via the aforementioned categories of wireless transports. The remote resources coupled to device B 410 may be of the types corresponding to the examples listed above with respect to device A 400. It is also important to note that, at least in the disclosed example, while device A 400 is linked to remote resource A 402, remote resource B 404 and remote resource C 406, and device B 410 is coupled to remote resource D 412, remote resource E 414 and remote resource F 416, that no wireless links have been configured between device A 400 and the resources coupled to device B 410, as well as between device B 410 and the resources coupled to device A 400. As a result, as shown at 420 it is unclear as to how a device on one of these segregated networks may gain access to a resource on the other network. For the sake of explanation in the present disclosure, establishing a connection between device A 400 and remote resource F 416, which belongs to the wireless network of resources coupled to device B 410, will now be discussed.

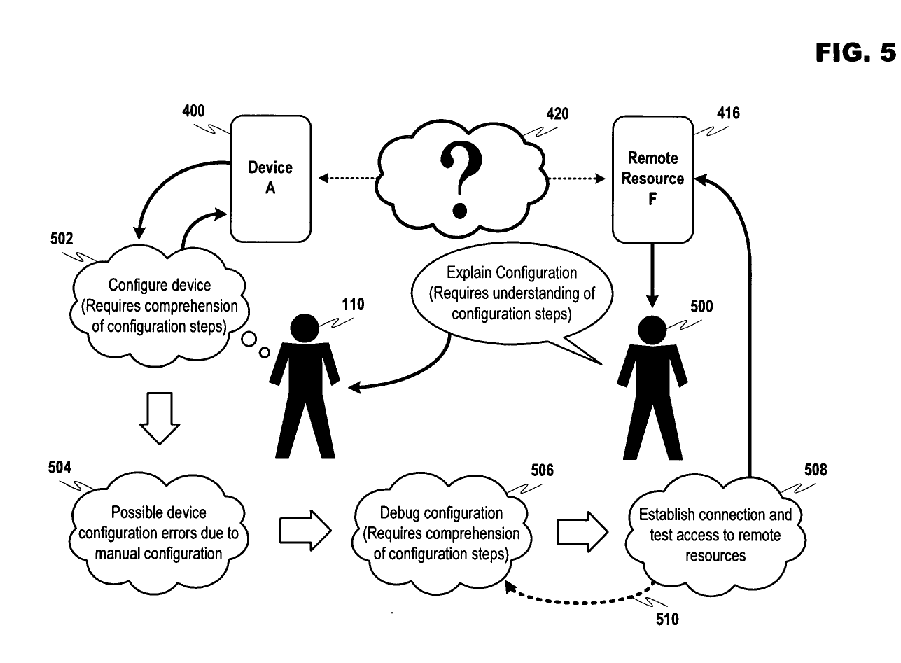

The exemplary scenario disclosed with respect to FIG. 5 describes a situation wherein access may only be granted from an apparatus to resources residing in another wireless network through manual configuration. In this example, user 110 may want to use device A 300 (e.g., WCD 100) to access remote resource F 316. The wireless access may be to, for example, obtain information from the remote resource, store information in the remote resource, control the remote resource, etc. Another user 500 currently has access to remote resource F 316 via a wireless communication connection configured in device B 410. In order for user 100 to access this remote resource, other user 500 must explain (e.g., via oral or written communication) the configuration steps to user 110. However, any explanation will require the understanding of the various steps needed to configure access. If other user 500 has a skill level limited only to using the device, explaining the steps required for configuration may be difficult to impossible.

Moreover, user 110 must interpret the steps narrated by other user 500 and apply them to device A 400. The application of these steps to device A 400 may vary slightly due to different apparatuses, operating systems, etc., and therefore, user 110 is not only required to comprehend the configuration steps recited by other user 500, but also must understand how to translate these steps for applying to device A 400 at 502. A foreseeable part of the configuration process is encountering communication problems due to, for example, configuration errors 504 that may be introduced either due to a lack of comprehension by user 110, or simply due to operator oversight. As a result, user 110 must then try to debug the connection at 506 in order to determine the incorrect setting. Debugging can be a lengthy process, especially if user 110 is not familiar with how to identify the source of the error, and once identified, how to correct it.

Even after a wireless link is successfully established between devices, the ability for user 110 to access the desired resources must still be verified at 506. Security provisions established in the remote resource may not allow user 110 to access resources if required codes and/or keys are not configured in device A 400. As a result, user 110 may have to again debug the configuration in order to establish the required level access to the desired remote resources. As is evident above, the manual configuration of wireless connections in order to access remote resource may includes many steps, and therefore, is fraught with many potential pitfalls that can make resource sharing, such as in the case of digital social networking, prohibitive to some users.

### IV. Automated Sharing by Close-Proximity Wireless Communication

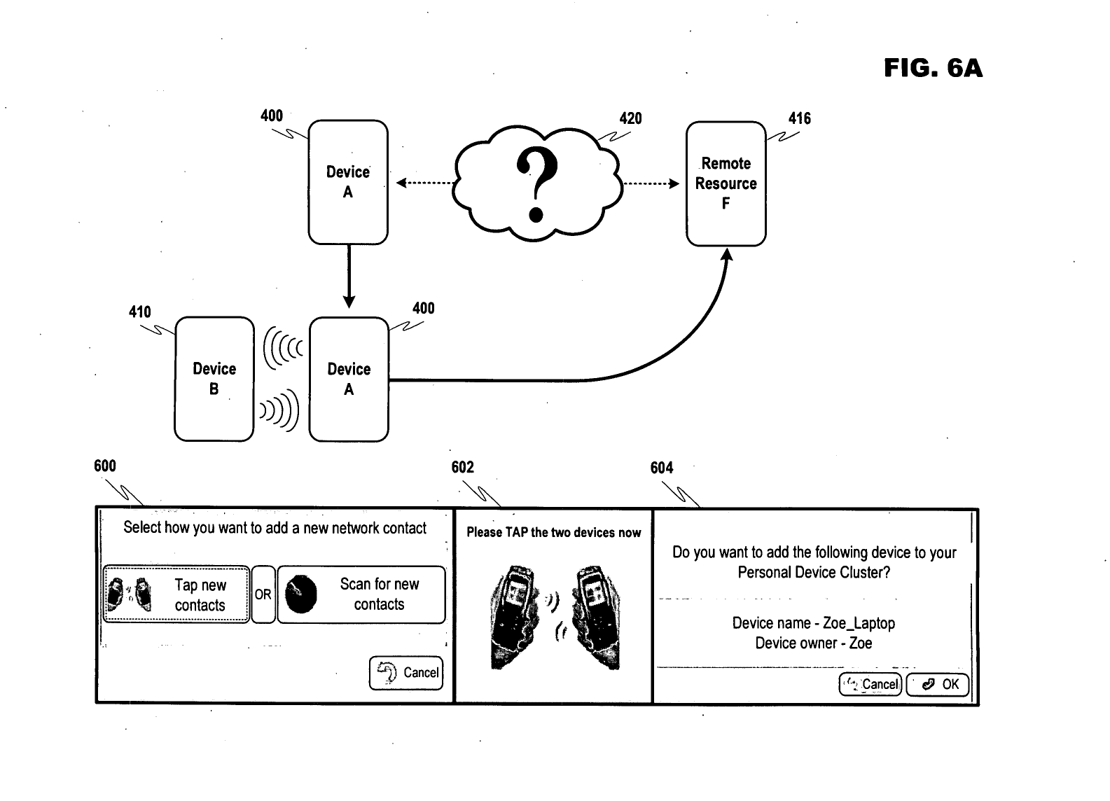

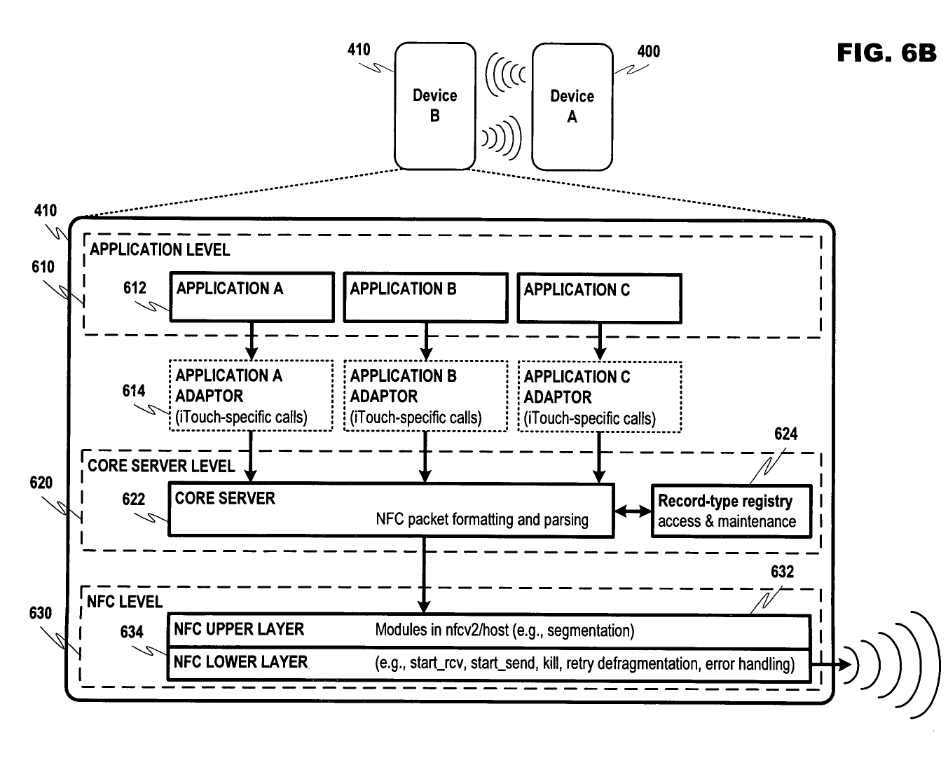

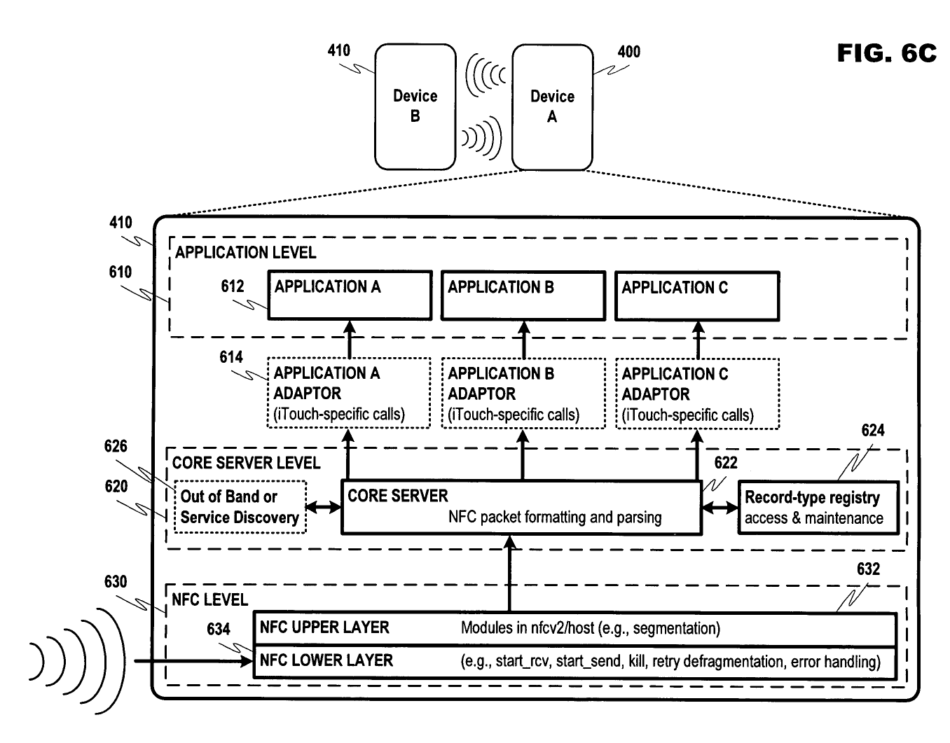

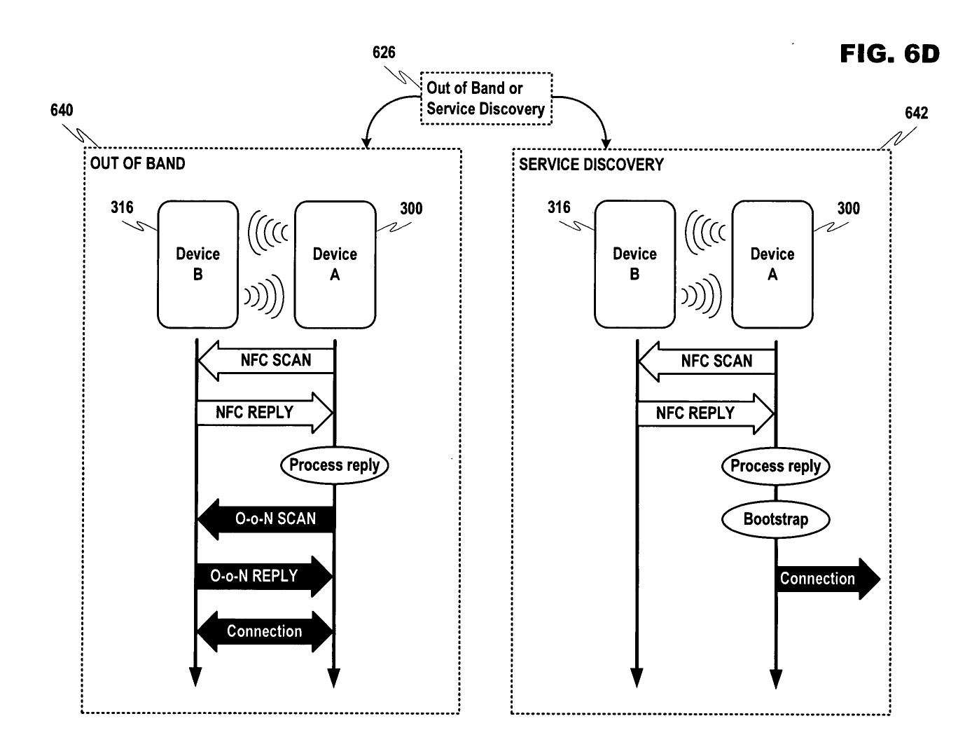

An exemplary embodiment of the present invention, in accordance with at least one embodiment, is now disclosed with respect to FIG. 6A. As in the example of FIG. 5, there exists a requirement 420 to establish access from device A 400 to remote resource F 416. However, instead of having to configure the wireless connection manually, device A 400 may obtain the information needed to access the remote resources from another device that already contains this information (e.g., device B 410) via close-proximity wireless communication. Once the configuration information has been obtained, modules in device A 400 may interpret the received configuration information in order to wirelessly access remote resource F 416.

An exemplary close-proximity wireless transaction is shown in FIG. 6A starting at 600. For example, user 110 may be adding a new member to their digital social network. In step 600 an application for obtaining configuration information may be invoked on device A 400. This application may inquire as to how the information should be obtained, and may further provide prompting for a user to execute a “Tap” process in step 602. The tap process may entail a user locating their device in close-proximity to the apparatus from which information is going to be obtained. In at least one embodiment of the present invention, a scan may then be triggered in device A 400, for example, by the pressing of a button. Alternatively, the scanning may start as soon as the configuration application prompts the user to move device A 400 into close-proximity with, for example, device B 410. Device A 400 may then scan device B 410 using close-proximity wireless communication (e.g., NFC), which may result in information being transferred from device B 410 to device A 400. In various embodiments of the present invention, an audible or visual signal may indicate that information has been received, and may be further followed by an inquiry as to whether an apparatus corresponding to the received information should be added to at least one device group established on device A 400. In the example shown, configuration information has been obtained for accessing “Zoe_Laptop,” and the inquiry regards whether this apparatus should be added to a “Personal Device Cluster.”

At least one benefit of utilizing close-proximity wireless communication when adding users/devices/services and/or data sharing, rather than more generalized local network discovery scans, is to help ensure that the device being “Tapped” is the same device that sent and/or replied to the initial scan. The assurance of identity may, in accordance with the various embodiments of the present invention, be beneficial to overall user community. This exemplary close (e.g., face-to-face) proximity during operation, when implemented correctly, may enhance the security of the system while providing a user interaction model that is both intuitive and simple. In particular, users may “point to” or touch an object with which they want to interact.

Now referring to FIG. 6B, a more detailed example of architecture and data flow in accordance with at least one embodiment of the present invention is now disclosed. An intermediate software layer for connecting applications in upper layers to system resources in lower layers (e.g., a “middleware “layer) may be used to implement the functionality described with respect to various embodiments of the present invention. In the particular example shown, a Linux-based architecture may allow “smart” apparatuses to communicate utilizing NFC in order to interact with other NFC-enabled apparatuses in their immediate physical proximity. The recitation of NFC in the present disclosure (e.g., in FIG. 6B and the following figures) is only for the sake of explanation, and is therefore not intended to be limit the various embodiments of the present invention disclosed herein. Any suitable close-proximity wireless medium may be used. The exemplary middleware disclosed in FIG. 6B may be used in conjunction with a variety of applications (e.g. Web Browser), service discovery protocols or P2P networking frameworks.

In FIG. 6B it is assumed that device A 400 has already gone through the process step of sending a close-proximity wireless request to device B 410, for example, as described in FIG. 6A. Application layer 610 may include software applications 612 that are executable in an apparatus (e.g., device B 410). These applications may, in some instances, be able to interact directly with core server level 620. Otherwise, they may be coupled to core server level 620 via interfaces or adaptors 614 that may provide command functionality specific to the data exchange and configuration process. “iTouch” has been used as an exemplary working name to represent the commercial application of various exemplary embodiments of the present invention to real world use. The use of “iTouch” is not intended to limit the present disclosure in any manner.

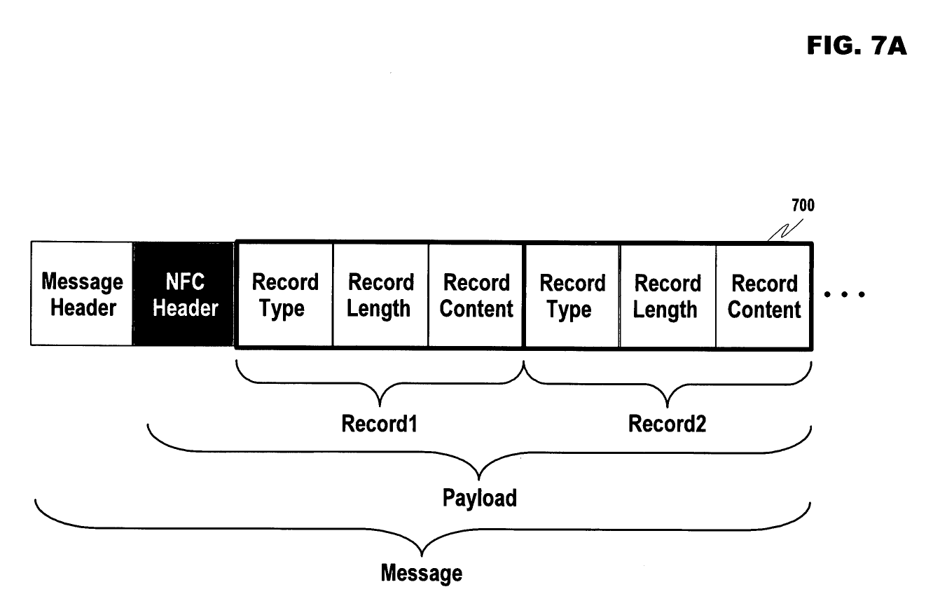

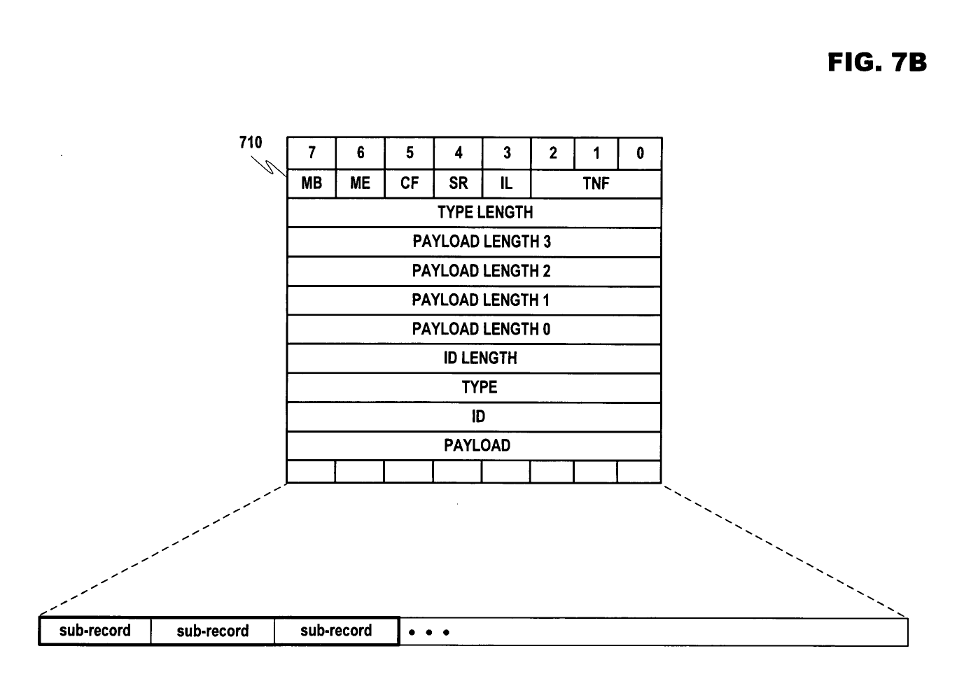

In accordance with at least one embodiment of the present invention, an iTouch adaptor 614 may sometimes be utilized to: (1) provide “glue” functionality allowing applications 612 to use the iTouch channel(s) without requiring any knowledge of NFC level 630. Application 612 may use components of iTouch middleware as a wireless proximity communication channel, or alternatively, may not be iTouch aware. Example applications may include web browsers, MyNet applications, service discovery frameworks such as universal plug and play (UPnP), connection management applications, etc., or (2) support a non-running client application. An adaptor 614 may be a launcher application that subscribes to receive a record type on behalf of application 612. When a record is received (an exemplary record structure is described in further detail with respect to FIG. 7B), adaptor 614 may launch application 612, and may further use the record payload as an input. In a scenario where application 612 is a web browser, adaptor 614 may receive an NFC packet containing uniform resource locator (URL) record information. Adaptor 614 may then launch Application 612 (e.g., the browser) with payload data (e.g., the URL) as input.

Core layer 620 may be implemented including core server 622 to which clients (e.g., applications such as network groups, service discovery protocols, connection managers) can subscribe, and thus, share access to a wireless interface (e.g., NFC level 630). To support shared access to NFC level 630 between multiple applications, each instance of an NFC session may be bound to an endpoint selector (a unique string) identifying the NFC data type to be delivered to application 612. Each application may register for one or more endpoint selectors before it may access communication resources in NFC level 630. Similarly, data read from the NFC interface may carry a selector. Simultaneous registration for the same selector by multiple applications may be disallowed. Subscriptions may be stored in Record Type Registry 624, which may include, for example, a simple database that stores records (e.g., including NFC record type, socket). Sockets may represent a socket on which an application 612 is listening. Core level 620, (e.g., core server 622) may combine or subdivide outgoing records into packets appropriately sized for the employed NFC technology before passing them to the NFC level 630.

In NFC level 630, upper NFC layer 632 and lower NFC layer 634 may comprise supporting software modules specific to the particular wireless close-proximity technology and HW being used to implement the present invention, in accordance with at least one embodiment. In the disclosed example, the technology being employed is NFC. NFC upper layer 632 and NFC lower layer 634 may implement functionality such as, but not limited to, activating or deactivating a radio, resetting a radio, low level functions to select a particular operation mode for a NFC radio (e.g., polling/sending mode), segmentation and/or reassembly of NFC packets sent to and received from frames that are transmitted over the air interface, error handling, etc.

In the example of FIG. 6B, information is being sent from device B 410 to device A 400. However, the various embodiments of the present invention are not limited as such. An example of information reception is shown with respect to FIG. 6C. Information transferred via close-proximity wireless communication (e.g., NFC) may be received in NFC level 630 and may in turn be transferred up to application level 610 in manner opposite to that disclosed to FIG. 6B. Core server level 620 entities (e.g., core server 622) may parse received NFC packets to extract NFC records. Based on record type, core server layer 620 may deliver records to corresponding applications, or alternatively, to specialized iTouch modules (an example of which is shown at 626 in FIG. 6C). Specialized modules may, for example, initiate a connection setup or bootstrap a service discovery process before delivering any information to a subscribed client application.

Specialized modules 626 may perform dedicated tasks and add value to various embodiments of the present invention. Each specialized module 626 may process one or more NFC record types. In other words, when core layer 620 receives “record1” type records, it may pass them to a corresponding module for processing, which may pass resulting data to a client application that has subscribed for record1 type records. For outgoing data, record1 type processing modules may package the payload into record1 NFC records before passing them to core server 622. Record-specific middleware modules may be incrementally added to core layer 620. Examples of such modular functionality are disclosed in FIG. 6D, and may include Out-of-band (O-o-B) discovery 640 and Service Discovery 642.

Out-of-band (O-o-B) discovery 640 may be defined as the process of obtaining discovery parameters needed to invoke a service outside the usual channels of processing service discovery queries. NFC is a lower-power radio that may be exploited to discover nearby devices while keeping higher-power radios turned off during quiescent operation. In one scenario, user 110 may be prompted to bring his/her NFC-equipped initiator device in close-proximity to the NFC-equipped target device in the environment and arm the NFC transceiver (e.g., via a key press). This action may then trigger the reading of configuration information including a service description from another device. The discovery process may then establish a communication link with the discovered device, and may further bootstrap the mechanism for service invocation.

Once the service interfaces are known to an apparatus, the device may make remote procedure calls and subscribe for event notifications. Due to the short operating range of NFC, a client device need only wait for one response to be collected from the environment, reducing discovery latency. This selectivity may also avoid response implosion problems associated with the traditional forms of discovery. An example of this functionality may include transitioning to WLAN or Bluetooth™ after receiving the configuration information via NFC. O-o-B Connectivity 640 may declare its own record type(s). When a record type associated with O-o-B Connectivity 640 is extracted from a NFC packet in Core layer 620, these records may be passed to this module for parsing, processing and connection establishment. The subsequent connection that is established may be identified in the record, or alternatively, may be selected by the requesting device (e.g., device A 400) based on the availability of wireless mediums.

Service Discovery 642 may include modules configured for pre-configuring or “bootstrapping” service discovery in one or more protocols. Service Discovery 642 may declare its own record type(s) that contain at least service discovery description information.

Configuration information may be exchanged over an NFC interface in the form of NFC packets. NFC packet 700, as disclosed in FIG. 7A, is a flexible and extensible packet structure that may be used in a variety of use cases. Any configuration information that may be exchanged between apparatuses resides in the payload. An example of records being disposed in the payload of a NFC packet is shown in FIG. 7B. The payload may contain a header 710 and a record list with one or more records. Header 710 may contain the length of the payload, which may be used to determine the length of meaningful data to be exchanged. Each record in the payload may consist of a sequence of three elements, a triplet of (e.g., type, content-length and content). The record type may identify the structure and semantics of a record by providing a type name. Content-Length may identify the length of the record content. The record content may contain the actual configuration data. Various data records may comprise different types of configuration data. Examples of configuration data may include wireless link configuration data, service configuration/establishment information for services that may be hosted by the apparatus supplying the information, pieces of content, etc. Records may be nested to allow grouping of related data items. This payload organization allows for the representation of variable length and variable format data in a manner that may be similar to XML, but in a more compact notation that will work with memory constraints that govern the operation of some NFC transponders.

### V. Example Applications of at Least One Embodiment of the Present Invention

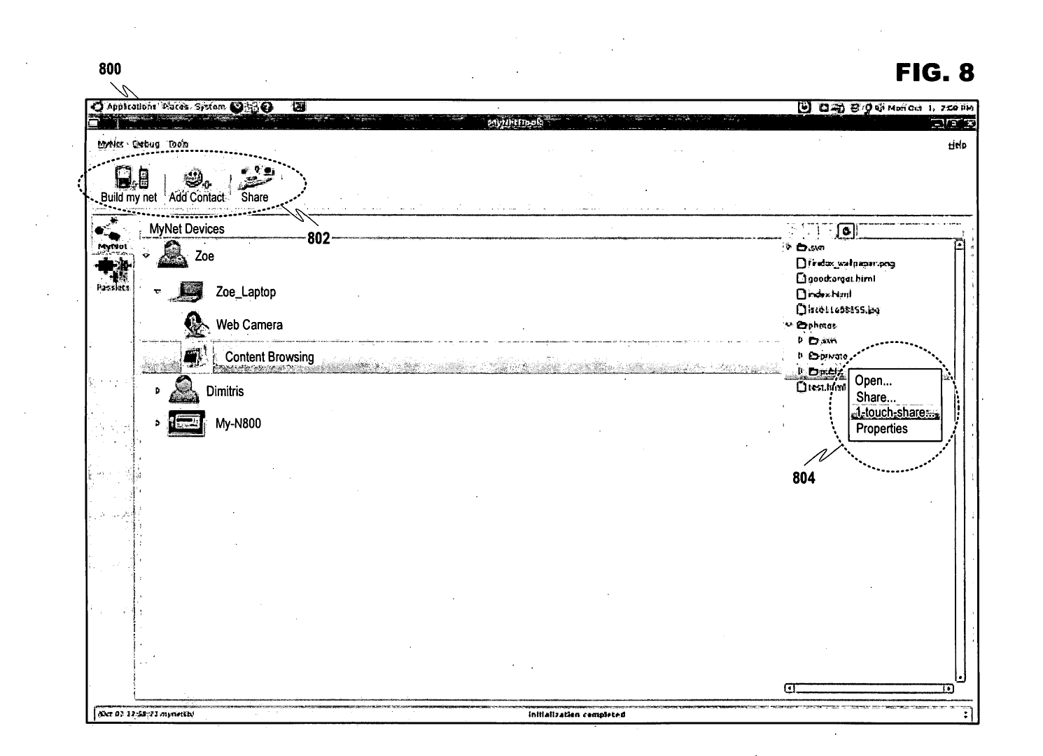

In accordance with various embodiments of the present invention, establishment and management of personal and/or social network groups may be simplified by using iTouch. Users may interact with personal network group architectures like MyNet via organizational user interfaces (e.g., MyNetBook 800 shown in FIG. 8). While specific applications (e.g., MyNet and MyNetBook 800) have been identified for the sake of explanation in this example, the core ideas discussed with respect to the various embodiments of the present invention may be implemented for other query-based service discovery protocols not discussed herein. The following examples, however, assume that devices implementing service discovery incorporate iTouch functionality.

An introduction process, in accordance with at least one embodiment of the present invention, may take place as the initial stage of a peer service discovery process. Upon creation, each discoverable resource (e.g., user, device, service or content) may create a peer discovery record, referred to herein as a Resource Advertisement Record (RAR). A RAR may contain pieces of data about resources that trigger the service discovery process. A P2P Service Discovery application (e.g. MyNet Secure Service Discovery Module) may then subscribe using the iTouch middleware for conveying the NFC RAR records.

The Introductions process may uses the iTouch middleware architecture in order to obtain discovery parameters needed to access a resource outside the usual channels of processing service discovery queries. When the user wants to discover a new resource, he/she may be prompted to locate the “initiator” device in close-proximity with the “target” device and arm the NFC transceiver (e.g. by pressing a key). This action may trigger a one-way transmission (or in some cases an exchange) of a RAR. When the RAR of the target device is received by the iTouch middleware of the initiator device, it may be passed to the Secure Resource Discovery Module (SRDM). When the Introduction process is completed, a Resource Discovery Record (RDR) is created and stored for the new contact/device. Configuration information may then be exchanged over an NFC interface in the format of NFC packets which contain Service Discovery NFC records. The RAR is included in the record content, as previously described.

The above iTouch-based Introduction process may be used to trigger the MyNet-aware service discovery for any MyNet-aware resource (e.g., adding personal devices or services into the personal apparatus (e.g., WCD 100), linking WCD 100 to other MyNet peer's devices, adding new MyNet contacts/peers, etc.) The iTouch architecture may also be used to provide an alternative channel for sharing between MyNet peers (e.g., other channels may include other wireless or wired protocols). Sharing may be performed using passlets (e.g., real-world metaphors of “passes” or “e-tickets”) where the user specifies what he/she wants to share, with whom and for how long. These configurations may be defined using controls 802 in exemplary interface 800.

The passlet may then be sent to a recipient, and the system may translate user-level permissions to system-level permissions. This allows MyNet users to share access to content, services and devices. They can share access to any resource on any personal wireless-enabled device. It does not have to be the apparatus that created and sent the passlets. Likewise, a recipient may utilize a passlet from any personal device in his/her WCD 100. In particular, a user may create new passlets or edit existing ones by using an interface like MyNetBook installed, for example, on WCD 100 to create access to resources (device, service, content) on any other apparatus. “Tapping” a recipient device with a device having the passlet may send it to the receiving device. Sharing may take place either by sending passlets over an NFC interface, or by receiving RAR records of a recipient through the NFC interface, and using the routing data to send the passlet over another primary channel.

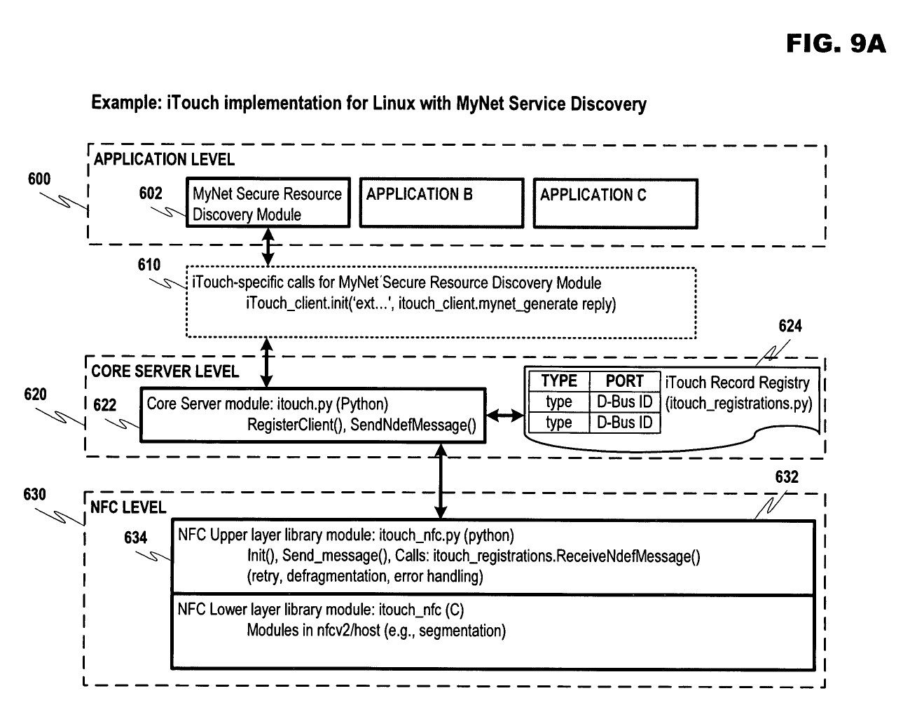

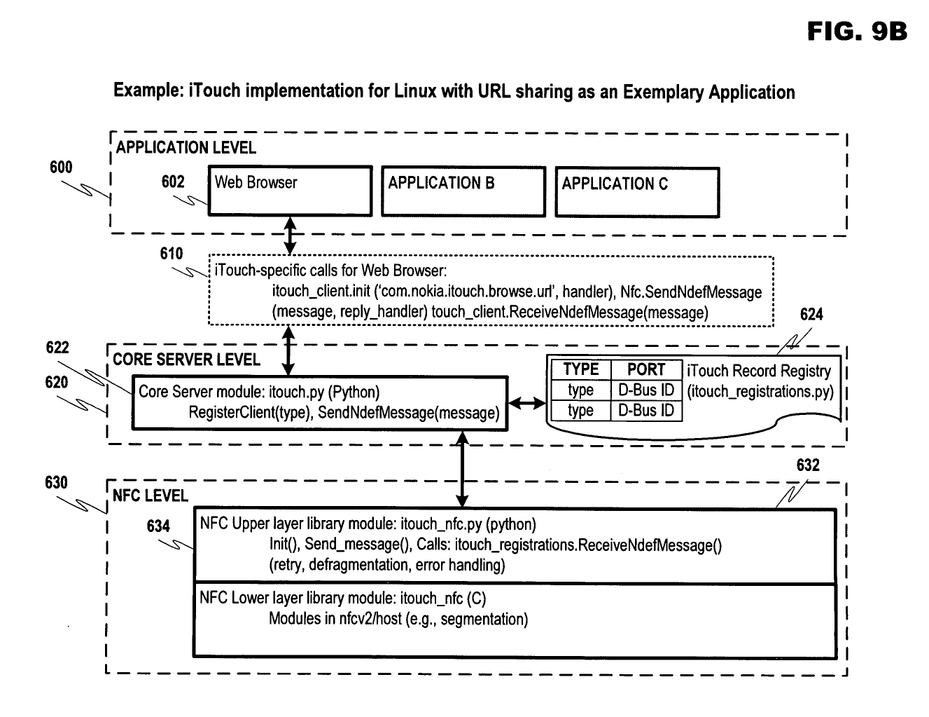

In an exemplary one-Touch-Sharing configuration, a user may use MyNetBook from any device (e.g., WCD 100) to select any resource (device, service, content) on any wireless-enabled apparatus by simply highlighting it, clicking on the one-Touch-Share option (e.g., soft button, hot-button, right-click menu option as shown at 804 in FIG. 9) and tapping a recipient device. This process requires the minimum number of manual steps for end-user. The result of this process is a passlet being created for the selected resource (e.g., via MyNetBook) and recipient via tapping. Again, sharing may take place either by sending the passlet itself via NFC, or by reading the RAR records of the recipient through the NFC interface and using the routing data to send the passlet over another primary channel.

### V. Specific Use Cases

The above described exemplary iTouch architecture, in accordance with at least one embodiment of the present invention, may be implemented for Linux based devices. The exemplary implementation, shown in FIGS. 9A and 9B, may be run on Linux-based laptops and tablets. The software modules for this implementation have been written in C and Python.

This exemplary iTouch implementation is divided into three main pieces: low-level itouch_nfc process (written in C) the core iTouch daemon (written in Python) and an optional itouch_client Python module that iTouch-aware applications may use to simplify registering for and receiving iTouch messages. The itouch_nfc module may be a separate process that manages one complete message roundtrip over the iTouch radio hardware. It may be run in one of two modes: initiator or responder, which is the normal quiescent state when no outgoing message is waiting to be sent. When started in responder mode, the process may, for example, initialize NFC hardware that may be attached as a USB device, set the NFC radio to receive only, and wait for an incoming packet. As stated above, support for close-proximity wireless communication (e.g., NFC) may also be integrated within the device itself. When such a packet arrives, it may write the data as a standard output, which is a pipe to the main iTouch daemon. The system may then wait for a response from the main iTouch module, send the response over the radio, and then exit.

When started in initiator mode, the data flow may be the same, but may occur in a different order. After configuring an NFC radio to prepare to send an NFC packet, itouch_nfc reads the packet data from the iTouch daemon on its standard input and forwards the packet to the NFC hardware. The system may then wait for a response, passes the reply back up to the iTouch daemon, and exits. If no successful send operation completes within a predetermined timeframe (e.g., 10 seconds), the itouch_nfc procedure may exit and the iTouch daemon can restart itouch_nfc when necessary. The iTouch daemon may expose a set of client API calls via an interface (e.g., a D-Bus interface) that may be employed for client registrations, for parsing and validating incoming NDEF messages, for monitoring and restarting the itouch_nfc module when changing mode, and for routing incoming packets to the appropriate registered client.

Exemplary API calls that may be available to iTouch clients at the D-Bus path (e.g., ‘/com/nokia/iTouch’) and interface (e.g., ‘com.nokia.iTouch’) may include: RegisterClient(RAR-type), which adds the client to the record type registry for the appropriate type, SendNdefMessage(message), which sends an outgoing message and later returns the reply, ReceiveNdefMessage( ), when the iTouch daemon receives an incoming message and determines an appropriate match for the RAR type in the message, it may then call this method at the interface ‘com.nokia.iTouch.client’ and D-Bus path (e.g., ‘/com/nokia/iTouch/client’) on the client.

The itouch_client Python module may contain an init( ) function for initializing the connection to the iTouch daemon, registering a RAR type for receiving incoming messages, starting up and registering the interface (e.g., a D-Bus interface) to receive incoming messages for the ‘com.nokia.iTouch.client’ interface. This module is not necessary for clients, but may be provided for Python applications to use if desired.

In the implementation example of FIG. 9A, MyNet may start up an itouch_client module, and may registers a callback for the type (e.g., ‘urn:nfc:ext:nokia.com:mynet’) that may provide a callback for incoming messages to a procedure called, for example, mynet_generate_reply( ), which may then return an advertisement.

In the exemplary case of URL sharing shown in FIG. 9B, the URL receiving side may start an itouch_client module registered to accept a specific message type (e.g., ‘urn:nfc:ext:Nokia.com:itouch.browseurl’). The client module may then await incoming messages. When an incoming message is received, the client module may pass the message payload (in this example a URL) to the appropriate web browser (e.g., Firefox or Opera). The URL sending side may also start up an itouch_client module, but may register no incoming types, and may instead sends a message containing the URL to send as payload, and type as, for example, ‘urn:nfc:ext:Nokia.com:itouch.browseurl’.

MyNet Introductions may use API calls exposed by the Out-of-Band Intro module to invoke NFC-based MyNet peer discovery, also known as “Tapping.” A RAR record may contain, for example, the following fields: Device EID, Device root SID (e.g., =device owner SID), Router hints (e.g., =EID, IP_address, port), Device friendly name, Device type, Owner name, etc.

When a user initiates a TAP operation, MyNet may construct an appropriate RAR record and pass it to the itouch client stub by calling a method, for example, itouch_client.initiate_discovery(RAR). The client stub may pack the RAR into an NDEF packet, and may use a D-Bus call to a method such as iTouch SendNdefMessage( ). The system may then wait for a reply. If the discovery is successful (e.g., that a target is in close-proximity) then a reply RAR from the target device may be passed to a MyNet Secure Service Discovery Module to complete the discovery process.

The MyNet RAR may be defined as, for example, ‘um:nfc:ext:nokia.com:mynet.’ When such a record is received by a target device, it may be passed from iTouch core 620 through the iTouch type registry 624, which then may forward the incoming RAR to a D-Bus method, for example, iTouchClient.ReceiveNdefMessage( ) provided by the target device's MyNet itouch_client module. The itouch_client may then call the handler, which in this example is the itouch_client.mynet_generate_reply(message) method. The incoming RAR may not be used immediately, but is available for future use. The mynet_generate_reply( ) method may then construct a RAR for the target device, and pass the RAR back to the device which initiated the tap. The configuration information may get passed as a method reply across the D-Bus interface to the iTouch core, and then back across the NFC interface to the initiating device.

An exemplary RAR may constructed based, for instance, on an NFC packet format. In such an implementation it may be an NDEF message which contains a MyNet peer discovery record: MB (message begin)=0x01, ME (message end)=0x00 or 0x01, depending on whether the data is encapsulated in one message (one payload) or multiple (chunked) ones, CF (chunk flag)=0x00 or 0x01. If set, this is the first or middle record chunk of a chunked payload, SR (short record)=0x01 or 0x01, depending on the payload length. If set, the PAYLOAD_LENGTH field is a single octet and the payload size is between 0-255 bytes. Else, the PAYLOAD_LENGTH field is four octets. For payloads>232-1 bytes, the chunked payload is used, IL (ID length)=0x00 by default, unless a URI is used for the record type identifier, TNF (Type Name Format)=0x04, this is equivalent to the NFC Forum external type. If the chunked record technique is used see for details. Alternatively, the type can be defined by an absolute URI with TNF set to 0x03, TYPE_LENGTH=unassigned 8-bit integer to specify the record type length in octets, ID_LENGTH=not included if IL=0x00, else the length of the URI, PAYLOAD_LENGTH=unassigned integer specifying the payload length in octets and TYPE=identifier describing the payload type, in this example: “urn:nfc:ext:nokia.com:mynet”. This can also be an absolute URI if TNF=0x03, ID=not included by default, else a URI, PAYLOAD=this contains the payload. The payload is opaque to the NFC layer, and therefore, may be specific to the application.

The payload in the disclosed example may contain the following fields: Device EID, Device root SID (e.g., =device owner SID), Router hints (e.g., =EID, IP_address, port), Device friendly name, Device type and Owner name. Further, the payload may be formatted as follows: the payload may be organized in a sequence of sub-record tuples, triplets of (Type, Content-Length, Content). The sub-record Type may identify the structure and semantics of the sub-record. The sub-record Content-Length may identify the length of the Content. The sub-record Record Content may then contain the actual data. Alternatively, a fixed sequence of sub-records may be assigned and, thus, only need to define the (Content-Length, Content). In another exemplary configuration a termination character can be added to the fixed sub-record configuration so that only the content needs to be specified.

### VI. Exemplary Process Flow

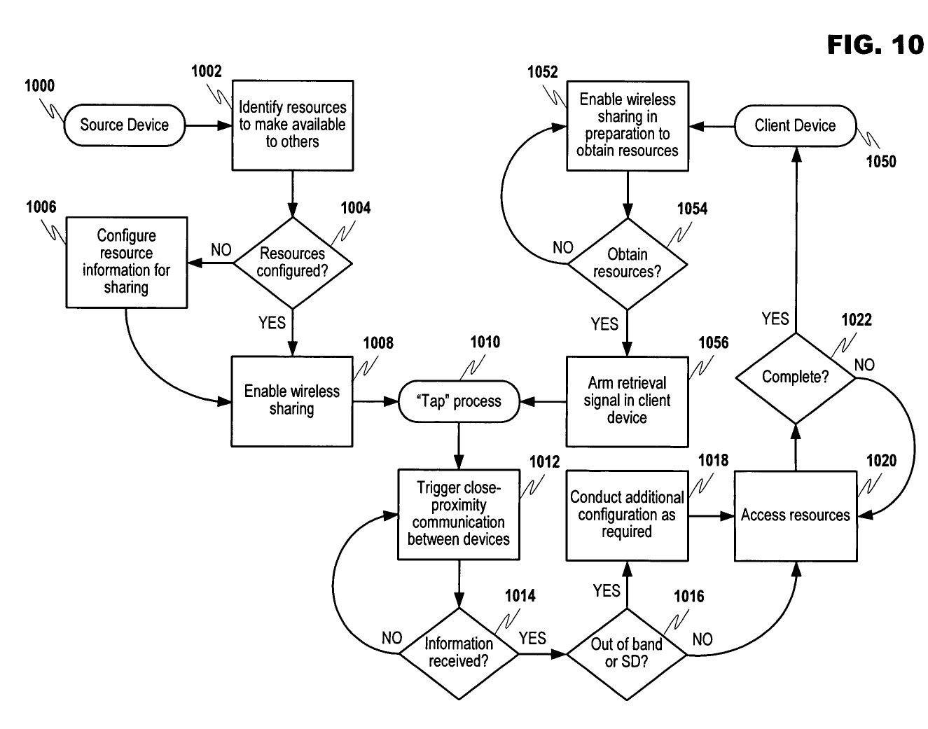

A flowchart disclosing exemplary processes for executing the present invention, in accordance with at least one embodiment, is shown in FIG. 10. The process flow consists of two separate flows, one for the source device and one for the client device, that come together at step 1010. Initially, the source device flow 1000 will be described. In step 1002, a user may identify resources within a network group to which the source belongs to make available to other devices. If these resources are not configured (step 1004) then the resources may be configured in step 1006, for example, by creating a RAR for each resource to be shared. Sharing may then be enabled in step 1008, and the source device may await an inquiry from the client device.

The client device exemplary process flow 1050 begins at step 1052. In this step an application for obtaining resource information may be activated. This application may be, for example, MyNet as previously described. When a user wants to obtain resources (step 1054), the user may arm the retrieval signal in the client in step 1056. Both devices may then participate in the “Tap” process flow disclosed at 1010. In this process the source and client devices may be placed in close-proximity to each other (step 1012), and then, in accordance with at least one embodiment of the present invention, a user may trigger the scanning process, for example, through pressing a key (e.g., this activity may be prompted by the device in the form of instructions displayed to the user). The scanning process may continue in step 1014 until the requested information is received. A determination may then be made in step 1016 as to whether additional processes (e.g., Out of Band or Service Discovery) are required before the desired resources may be accessed. If one or both of these processes are required, then in 1018 an additional communication link may be established in accordance with the requirements of the configuration. Eventually the client device may be able to access the remote resources in step 1020, and the link to the remote resources may continue until a determination is made that access to these resources are no longer necessary in step 1022. The process may then resume at 1050.

It is further important to realize that step 1014 of the exemplary flowchart shown in FIG. 10 may also be performed in a reverse (e.g., a user “Taps” another device to send data instead of receive data). This scenario may occur, for example, in instances where users want to grant permission to access resources to other devices without the need for manual configuration.

Accordingly, it will be apparent to persons skilled in the relevant art that various changes in forma and detail can be made therein without departing from the spirit and scope of the invention. The breadth and scope of the present invention should not be limited by any of the above-described exemplary embodiments, but should be defined only in accordance with the following claims and their equivalents.

What is claimed:

1. A method, comprising:
activating a mode in an apparatus, the activated mode configuring the apparatus to send configuration information to, or receive configuration information from, at least one other apparatus via close-proximity wireless communication;
transferring the configuration information between the apparatus and the at least one other apparatus via close-proximity wireless communication;
determining, based on the configuration information, if additional communication is required in order to complete configuration in an apparatus that received the configuration information, and if additional configuration is required, initiating additional communication for the apparatus that received the configuration information; and
configuring the apparatus that received the configuration information using at least one of the received configuration information or the additional communication.

2. The method of claim 1, wherein the activated mode further prepares configuration information in the apparatus for transmission via close proximity wireless communication, prompts a user to move the apparatus into close-proximity with the at least one other apparatus, and prompts the user to trigger the transfer.

3. The method of claim 1, wherein the activated mode configures the apparatus to receive configuration information via close-proximity wireless communication, prompts a user to move the apparatus into close-proximity with the at least one other apparatus, and prompts the user to trigger the transfer.

4. The method of claim 1, wherein the configuration information comprises a data record including at least one of a networking peer user, a device announcement, wireless link configuration data, service configuration/establishment data or content-related data.

5. The method of claim 1, wherein the close-proximity wireless communication is near field communication (NFC).

6. The method of claim 1, wherein the additional communication comprises establishing an out-of-band connection in order to complete configuration.

7. The method of claim 6, wherein the out-of-band connection comprises establishing a short-range wireless connection between devices using a different wireless medium.

8. The method of claim 1, wherein additional communication comprises pre-configuring service discovery for one or more wireless mediums in order to complete configuration.

9. The method of claim 1, wherein configuring the apparatus that received the configuration information comprises adding at least one member to at least one of an apparatus group or a user group residing in the apparatus, the at least one member including the at least one other apparatus or another user.

10. The method of claim 1, wherein configuring the apparatus that received the configuration information comprises accessing resources located remotely to the apparatus that received the configuration information via wireless communication.

11. A computer program product comprising a computer usable medium having computer readable program code embodied in said medium, comprising:
a computer readable program code configured to activate a mode in an apparatus, the activated mode configuring the apparatus to send configuration information to, or receive configuration information from, at least one other apparatus via close-proximity wireless communication;
a computer readable program code configured to transfer the configuration information between the apparatus and the at least one other apparatus via close-proximity wireless communication;
a computer readable program code configured to determine, based on the configuration information, if additional communication is required in order to complete configuration in an apparatus that received the configuration information, and if additional configuration is required, initiating additional communication for the apparatus that received the configuration information; and
a computer readable program code configured to configure the apparatus that received the configuration information using at least one of the received configuration information or the additional communication.

12. The computer program product of claim 11, wherein the activated mode further prepares configuration information in the apparatus for transmission via close proximity wireless communication, prompts a user to move the apparatus into close-proximity with the at least one other apparatus, and prompts the user to trigger the transfer.

13. The computer program product of claim 11, wherein the activated mode configures the apparatus to receive configuration information via close-proximity wireless communication, prompts a user to move the apparatus into close-proximity with the at least one other apparatus, and prompts the user to trigger the transfer.

14. The computer program product of claim 11, wherein the configuration information comprises a data record including at least one of a networking peer user, a device announcement, wireless link configuration data, service configuration/establishment data or content-related data.

15. The computer program product of claim 11, wherein the close-proximity wireless communication is near field communication (NFC).

16. The computer program product of claim 11, wherein the additional communication comprises establishing an out-of-band connection in order to complete configuration.

17. The computer program product of claim 16, wherein the out-of-band connection comprises establishing a short-range wireless connection between devices using a different wireless medium.

18. The computer program product of claim 11, wherein additional communication comprises pre-configuring service discovery for one or more wireless mediums in order to complete configuration.

19. The computer program product of claim 11, wherein configuring the apparatus that received the configuration information comprises adding at least one member to at least one of an apparatus group or a user group residing in the apparatus, the at least one member including the at least one other apparatus or another user.

20. The computer program product of claim 11, wherein configuring the apparatus that received the configuration information comprises accessing resources located remotely to the apparatus that received the configuration information via wireless communication.

21. An apparatus, comprising:
at least one radio module configured to support close-proximity wireless communication; and
a controller, the controller being configured to:
activate a mode, the activated mode configuring the apparatus to send configuration information to, or receive configuration information from, at least one other apparatus via close-proximity wireless communication;
transfer the configuration information between the apparatus and the at least one other apparatus via close-proximity wireless communication;
determine, based on the configuration information, if additional communication is required in order to complete configuration in an apparatus that received the configuration information, and if additional configuration is required, initiating additional communication for the apparatus that received the configuration information; and
configure the apparatus that received the configuration information using at least one of the received configuration information or the additional communication.

22. The apparatus of claim 21, wherein the activated mode further prepares configuration information in the apparatus for transmission via close proximity wireless communication, prompts a user to move the apparatus into close-proximity with the at least one other apparatus, and prompts the user to trigger the transfer.

23. The apparatus of claim 21, wherein the activated mode configures the apparatus to receive configuration information via close-proximity wireless communication, prompts a user to move the apparatus into close-proximity with the at least one other apparatus, and prompts the user to trigger the transfer.

24. The apparatus of claim 21, wherein the configuration information comprises a data record including at least one of a networking peer user, a device announcement, wireless link configuration data, service configuration/establishment data or content-related data.

25. The apparatus of claim 21, wherein the close-proximity wireless communication is near field communication (NFC).

26. The apparatus of claim 21, wherein the additional communication comprises establishing an out-of-band connection in order to complete configuration.

27. The apparatus of claim 26, wherein the out-of-band connection comprises establishing a short-range wireless connection between devices using a different wireless medium.

28. The apparatus of claim 21, wherein additional communication comprises pre-configuring service discovery for one or more wireless mediums in order to complete configuration.

29. The apparatus of claim 21, wherein configuring the apparatus that received the configuration information comprises adding at least one member to at least one of an apparatus group or a user group residing in the apparatus, the at least one member including the at least one other apparatus or another user.

30. The apparatus of claim 21, wherein configuring the apparatus that received the configuration information comprises accessing resources located remotely to the apparatus that received the configuration information via wireless communication.

31. An apparatus, comprising:
means for activating a mode, the activated mode configuring the apparatus to send configuration information to, or receive configuration information from, at least one other apparatus via close-proximity wireless communication;
means for transferring the configuration information between the apparatus and the at least one other apparatus via close-proximity wireless communication;
means for determining, based on the configuration information, if additional communication is required in order to complete configuration in an apparatus that received the configuration information, and if additional configuration is required, initiating additional communication for the apparatus that received the configuration information; and
means for configuring the apparatus that received the configuration information using at least one of the received configuration information or the additional communication.

32. A system comprising:
a source apparatus; and
at least one client apparatus;
the at least one client apparatus activating a mode, the activated mode configuring the client apparatus to send configuration information to, or receive configuration information from, the source apparatus via close-proximity wireless communication;
transferring the configuration information from the source apparatus to the client apparatus via close-proximity wireless communication;
determining, based on the configuration information, if additional communication is required in order to complete configuration in the client apparatus, and if additional configuration is required, initiating additional communication for the client apparatus; and
configuring the client apparatus using at least one of the received configuration information or the additional communication.
